(19) United States
(12) Patent Application Publication
(10) Pub. No.: US 2007/0071252 A1
(43) Pub. Date: Mar. 29, 2007

(54) Microphone, hearing aid with a microphone and inlet structure for a microphone

(75) Inventors: Christian C. Burger, Smorum (DK); Jon Palle Hansen, Smorum (DK); Mark R. Sondersted, Smorum (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: OTICON A/S, SMORUM (DK)

(21) Appl. No.: 10/554,403

(22) PCT Filed: Apr. 22, 2004
(86) PCT No.: PCT/DK04/00276

§ 371 Date: Dec. 8, 2005

(30) Foreign Application Priority Data
Apr. 28, 2003 (DK) PA 2003 00638

(51) Int. Cl. H04R 1/02; H04R 3/00; H04R 9/08

(52) U.S. Cl. 381/91; 381/122; 381/357

(57) ABSTRACT

The invention comprises a microphone with a housing and an active element inside the housing for converting sound energy into electric energy whereby an inlet is provided for directing sound energy from the surroundings to the active element, whereby the inlet comprises a first tube part and a cavity in connection with the first tube part, whereby the cavity is dimensioned to dampen ultrasonic frequencies. The invention further comprises a hearing aid with a microphone such a microphone. Further the invention concerns an inlet structure for a microphone.

The invention relates to a microphone which is to receive an audio input and supply an electric output. The invention also relates to a hearing aid with a microphone and an inlet structure for a microphone.

### BACKGROUND OF THE INVENTION

Microphone systems are commonly constructed as a microphone unit connected to an amplifier unit which drives a device, e.g. a speaker. Most amplifiers are protected against to large input signal by means of an input AGC (automatic Gain Circuit). The AGC is basically a system that can change attenuation in a way so that the maximum output signal for further processing is kept within chosen limits.

A microphone unit also often contains a build-in amplifier circuit. The build-in amplifier has typically a fixed gain which accommodates the highest sound pressure input specified for the microphone.

Hearing aids most have a frequency bandwidth capable of supporting the user with speech information and a comfortable sound. This means a bandwidth of at a least 5 kHz in most situations. The optimum would be to have a bandwidth like the normal hearing at around 15 kHz to 20 kHz.

All frequencies above 20 kHz most be attenuated as much as possible in order to reduce unwanted side effects. Frequencies above 20 kHz are called ultrasound.

Ultrasound impacts the working of a hearing aid in that it can become demodulated both in the microphone and in the following amplifier. Ultrasound passing thru a microphone can act together with the input AGC and reduce the gain in the audio band unnecessary.

Ultrasound is used more and more in connection with burglary alarms, car alarms, automatic door openers and other applications.

This means that users of hearing aids and other electronic devices such as head sets become more exposed to ultrasound signals which cause the audio electronic devices to decrease gain or to emit demodulated noise or a combination of the two. This reduces the users benefit and is a course of annoyance.

### SUMMARY OF THE INVENTION

The purpose of the invention is to provide a microphone which is less sensitive to ultrasound. Such a microphone would be a big advantage in hearing aids or other audio electronic devises.

This is achieved with a microphone which has a housing and an active element inside the housing for converting sound energy into electric energy whereby an inlet is provided for directing sound energy from the surroundings to the active element, whereby the inlet comprises a first tube part and a cavity in connection with the first tube part, whereby the cavity is dimensioned to dampen ultrasonic frequencies. The cavity may be designed to dampen a specific frequency or may be designed to dampen a broader range of frequencies according to the specific needs.

According to an embodiment of the invention, the cavity has a dimension L which is around ¼ of the wavelength of the ultrasonic frequency to be damped. In this way the cavity will dampen a specific frequency and not have much impact on other frequencies.

In a further embodiment of the microphone the cavity is shaped as a second tube part with a length dimension L which varies slightly with the cross section of the tube. In this way it becomes possible to have a ¼ wave resonator, which has a somewhat broader target frequency. Hereby a broader range of ultrasonic frequencies may be dampened. Further the resonator has the side effect of enhancing frequencies in the audio range, which is usually undesirable, but this effect is minimized by the use of a resonator wherein the L dimension is not uniform across the tube.

In an embodiment of the invention the microphone has a second tube part, which is curved, and is arranged in a plane essentially perpendicular to the first tube part. Hereby it becomes possible to arrange the second tube part in a plane adjacent to the microphone housing in a block of material, which also comprises the first tube part. This makes the inlet system particularly simple to manufacture.

In a further embodiment the cavity or second tube part is arranged in close proximity of the microphone. Hereby the block containing the cavity or second tube part can be made with the cavity open to the surroundings, but such that when the block is assembled with the microphone the second tube part is closed by the surface of the microphone.

The invention also concerns a hearing aid with a microphone as described above. Such a hearing aid will be insensitive to the negative influences of the ultrasonic noise produced by burglar alarms, automatic door openers and other equipment which use ultrasonic emitting transducers. As described above the AGC in a hearing aid may cause very annoying side effects to be produced when the hearing aid is subject to ultrasonic noise. The use of a microphone as described can help to avoid these un-pleasant side-effects.

The invention also comprises an inlet structure for a microphone. The inlet structure of the microphone will help to dampen ultrasonic frequencies, and thereby avoid that ultrasonic noise penetrates into the microphone.

### BRIEF DESCRIPTION OF THE DRAWINGS

FIG. 1 shows a diagram of a system with a microphone, amplifier and speaker according to the prior art,

FIG. 2 shows a diagram of a system having a microphone system with electrical low pass filter

FIG. 3 displays a diagram of a system having a microphone system with acoustical low pass filter

FIG. 4 shows a diagram of a system comprising a microphone system with both acoustical and electrical filter,

FIG. 5 shows schematically a microphone with tube

FIG. 6 shows in schematic form a microphone with tube and quarter wave resonator

FIG. 7 shows in schematic form a microphone with a tube and a broadband quarter wave resonator,

FIG. 8 shows an example of a microphone inlet system according to the invention,

FIG. 9 is the inlet in FIG. 8 seen from a different angle,

FIG. 10 show the frequency response of a microphone having either a simple tube, a tube with a quarter wave resonator of one dimension or a quarter wave resonator of an other dimension.

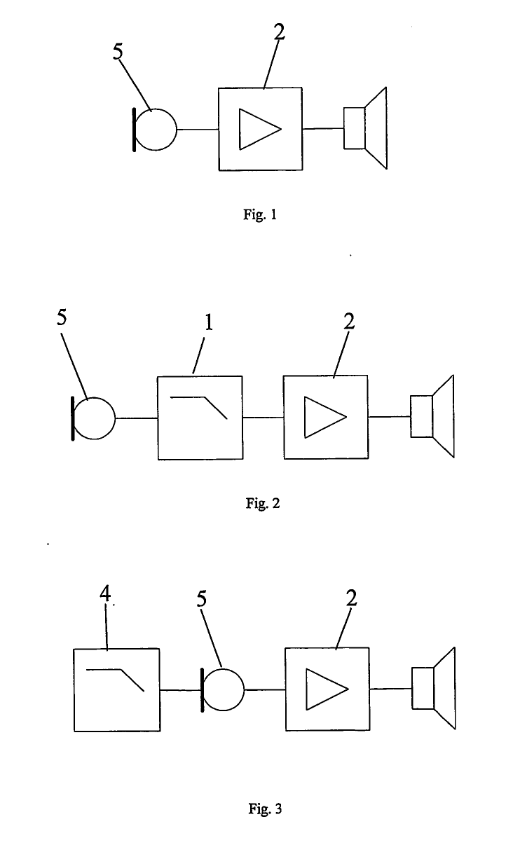

### DESCRIPTION OF A PREFERRED EMBODIMENT

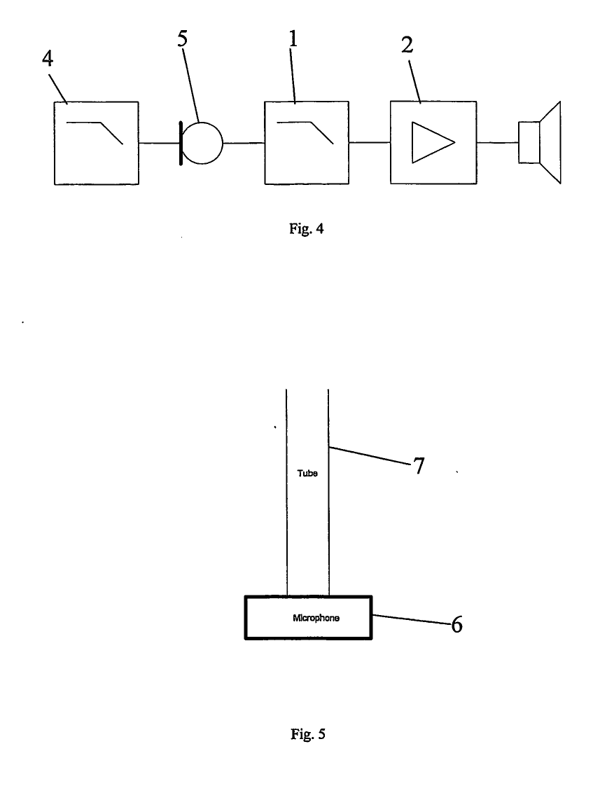

It is known to use a low pass filter 1 to reduce the amount of ultrasound signal presented to the amplifier as shown in FIG. 2.

The low pass filter 1 is implemented as an analogue circuit which reduces the ultrasound signal before it reaches the amplifier circuit 2 and becomes demodulated or affects the gain in the input AGC.

The system in FIG. 2 will only reduce part of the problem in that the part of the ultrasound signal that reaches the microphone is unaltered. Another problem is that the often used commercial ultrasound frequencies starts at 25 kHz, and this dictates a need for a high order low pass filter for better performance of the system.

Another system to suppress ultrasound signals is shown in FIG. 3.

Applying an acoustical filter 4 in front of the microphone 5 system will reduce the ultrasound both in connection with the microphone 5 and with the amplifier 2. The problem will normally be to achieve a high enough filter order to be sufficiently effective. This has proved difficult with present day technology.

FIG. 4 shows the combination of the solutions shown in FIG. 2 and 3. Attenuating the ultrasound both by acoustical 4 and electrical 1 means will provide a very high degree of protecting against the above mentioned ultrasound problems.

FIG. 5 shows an ordinary microphone system in a hearing aid. The system consists of a microphone 6 and a tube 7 leading to the surface of the hearing aid.

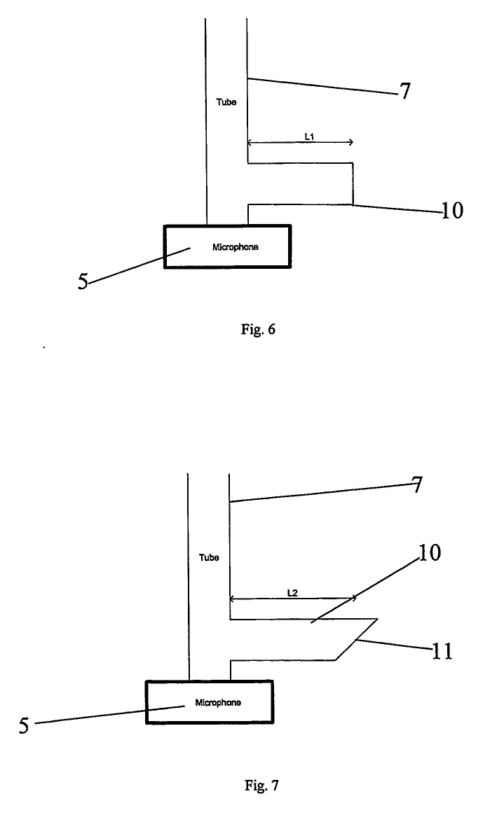

FIG. 6 shows a microphone with an inlet structure comprising a quarter wave resonator 10 suppressing ultrasound with a frequency corresponding to a wavelength of four times L1. The filter has a high Q.

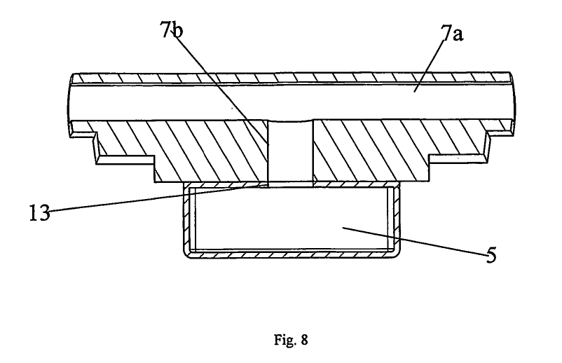

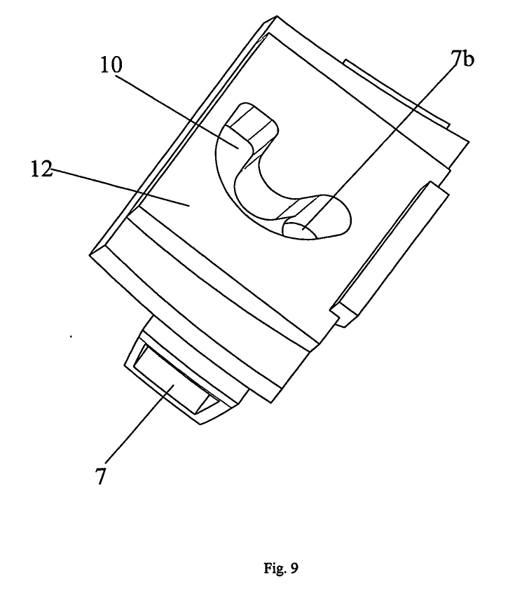

In FIG. 7 the inlet structure is modified with a broadband quarter wave resonator suppressing ultrasound with a mean frequency corresponding to a wavelength of four times L2. The added piece of closed tube with the inclined cut off 11 which gives the filter a lower Q than in FIG. 6 but with a higher filter bandwidth.

The broadband quarter wave resonator can be implemented in several ways, but the important thing is to design it in a way so that more than one length (as with the case of L1 in FIG. 6) is present in the tube. This can be accomplished by designing the end of the tube so that it represents a range of length (as in FIG. 7) corresponding to suppression of a range of frequencies. Ass seen in FIG. 7 the length L from the tube 7 to the end of tube 10 will depend on where in the cross section of the tube the length is measured.

The distribution of the length pr. area of the resonator will equal the filters band characteristic.

In FIG. 8 a cross section of an inlet structure and a microphone according to the invention is shown. The inlet has a first part 7a and a second part 7b leading to the microphone 5.

In FIG. 9 a perspective view of the microphone inlet structure of FIG. 8 is shown. Here the tube 10, which causes the damping of ultrasonic noise, is visible. The tube 10 branches of the tube part 7b right at the inlet to the microphone housing. As seen in FIG. 9 the tube part 10 is made in the wall structure of the inlet part and open to the surroundings. The tube becomes closed once the microphone 5 is mounted with a side face which is fastened to the surface 12 of the inlet structure. The length of the tube 10 is typically in the range of 2 to 6 mm. As seen in FIG. 9 the tube 10 does not have an inclined end. But due to the curvature of the tube 10 the length dimension will wary depending on cross section in which the length dimension is measured.

The microphone 5 can be glued or fastened by other means to the surface 12, only it must be assured, that the inlet 13 of the microphone 5 is placed on axis with the tube part 7b of the inlet structure.

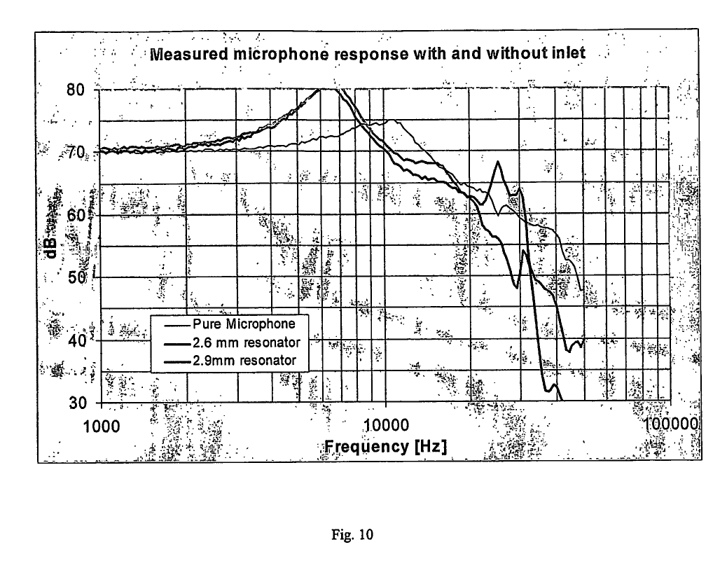

In FIG. 10 measurement results with tree different inlet systems are shown. As seen the two resonators provide a significant increase in the attenuation of the frequencies above 35 kH.

1. Microphone with housing and an active element inside the housing for converting sound energy into electric energy whereby an inlet is provided for directing sound energy from the surroundings to the active element, whereby the inlet comprises a first tube part and a cavity in connection with the first tube part, whereby the cavity is dimensioned to dampen ultrasonic frequencies, and where the cavity is shaped as a second tube part with a length dimension L which varies slightly with the cross section of the second tube part.

2. Microphone as claimed in claim 1, whereby the cavity has a dimension L which is around ¼ of the wavelength of the ultrasonic frequency to be damped.

3. Microphone as claimed in claim 2, whereby the second tube part is curved, and is arranged in a plane essentially perpendicular to the first tube part.

4. Microphone as claimed in claim 2, whereby the cavity or second tube part is arranged in close proximity of the microphone.

5. Hearing aid with a microphone as claimed in claim 1.

6. Inlet structure for a microphone, comprising a first tube part and a cavity in connection with the first tube part, whereby the cavity is dimensioned to dampen ultrasonic frequencies and where the cavity is shaped as a second tube part with a length dimension L which various slightly with the cross section of the second tube part.

7. Inlet structure for a microphone as claimed in claim 6, whereby the cavity has a dimension L which is around ¼ of the wavelength of the ultrasonic frequency to be damped.

8. Inlet structure for a microphone as claimed in claim 7, whereby the second tube part is curved, and is arranged in a plane essentially perpendicular to the first tube part.

9. Inlet structure for a microphone as claimed in claim 7, whereby the cavity or second tube part is arranged in close proximity of the microphone.

10. Inlet structure for a microphone as claimed in claim 9, whereby the second tube part is curved, and is arranged in a plane essentially perpendicular to the first tube part.

11. Inlet structure for a microphone as claimed in claim 8, whereby the cavity or second tube part is arranged in close proximity of the microphone.
